(19) United States
(12) Patent Application Publication
(10) Pub. No.: US 2026/0065861 A1
(43) Pub. Date: Mar. 5, 2026

(54) DISPLAY DEVICE AND ELECTRONIC DEVICE

(71) Applicant: Samsung Display Co., Ltd., Yongin-si (KR)

(72) Inventors: MINSU CHOI, Yongin-si (KR); KYUNGMO LEE, Yongin-si (KR)

(21) Appl. No.: 19/215,087

(22) Filed: May 21, 2025

(30) Foreign Application Priority Data
Sep. 2, 2024 (KR) 10-2024-0118348

(51) Int. Cl. G09G 3/3233; G09G 3/32

(52) U.S. Cl. CPC G09G 3/3233; G09G 3/32; G09G 2300/0819; G09G 2300/0842; G09G 2300/0861; G09G 2320/0233; G09G 2320/0238

(57) ABSTRACT

A display device includes a display panel including pixels, a data driver, a gate driver and a voltage generator configured to apply an initialization voltage to the display panel. The display panel includes a first display region and a reference display region. At least one pixel of the pixels includes a driving transistor configured to generate a driving current based on the data voltage, a light emitting element including a first electrode receiving the driving current and a second electrode receiving the low power voltage and an initialization transistor configured to apply the initialization voltage to the first electrode of the light emitting element. The initialization voltage includes a first region initialization voltage and a reference region initialization voltage. The first region initialization voltage applied to the first display region is inconsistent with the reference region initialization voltage applied to the reference display region.

### CROSS-REFERENCE TO RELATED APPLICATION

The present application claims priority to and the benefit of Korean Patent Application No. 10-2024-0118348, filed on Sep. 2, 2024 in the Korean Intellectual Property Office, the entire disclosure of which is incorporated herein by reference.

### BACKGROUND

### 1. Field

Aspects of some embodiments of the present disclosure relate to a display device and an electronic device.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

Generally, a pixel may include a light emitting element. An anode of the light emitting element may be initialized as an initialization voltage. The initialization voltage applied to each of pixels are same. Accordingly, a display quality of a display panel may be deteriorated.

The above information disclosed in this Background section is only for enhancement of understanding of the background and therefore the information discussed in this Background section does not necessarily constitute prior art.

### SUMMARY

Aspects of some embodiments of the present disclosure relate to a display device and an electronic device. For example, aspects of some embodiments of the present disclosure relate to a display device in which a display quality is relatively improved and an electronic device.

Aspects of some embodiments of the present disclosure also include a display device in which a display quality is relatively improved.

Aspects of some embodiments of the present disclosure may include an electronic device in which a display quality is relatively improved.

According to some embodiments, a display device may include a display panel including a plurality of pixels, a data driver configured to apply a data voltage to the display panel, a gate driver configured to output a gate signal to the pixels and a voltage generator configured to apply a low power voltage and an initialization voltage to the display panel. According to some embodiments, the display panel may include a first display region and a reference display region. According to some embodiments, at least one pixel of the pixels may include a driving transistor configured to generate a driving current based on the data voltage, a light emitting element including a first electrode receiving the driving current and a second electrode receiving the low power voltage and an initialization transistor configured to apply the initialization voltage to the first electrode of the light emitting element. According to some embodiments, the initialization voltage may include a first region initialization voltage and a reference region initialization voltage. According to some embodiments, the first region initialization voltage applied to the first display region may be inconsistent with the reference region initialization voltage applied to the reference display region.

According to some embodiments, the first region initialization voltage may be generated based on a reference initialization voltage and an initialization offset voltage. According to some embodiments, the initialization offset voltage may be calculated based on a difference of a luminance uniformity between the reference display region and the first display region.

According to some embodiments, the difference of the luminance uniformity may be determined by changing the first region initialization voltage. According to some embodiments, the initialization offset voltage may be calculated based on a changed first region initialization voltage in a minimum luminance uniformity in which the difference of the luminance uniformity is minimum.

According to some embodiments, the luminance uniformity may be a ratio between a luminance when a reference data voltage is applied to the reference display region and a luminance when the reference data voltage is applied to the first display region.

According to some embodiments, when the reference voltage is applied to the reference display region, the reference display region may emit as a target luminance.

According to some embodiments, the display panel may be generated based on a mother panel. According to some embodiments, the reference initialization voltage may be generated based on a location data of the display panel in the mother panel.

According to some embodiments, the mother panel may include a first mother region and a second mother region. According to some embodiments, a reference initialization voltage of a display panel generated from the first mother region may be higher than a reference initialization voltage of a display panel generated from the second mother region.

According to some embodiments, the mother panel may include a center region and an edge region. According to some embodiments, the first mother region may be the edge region and a second mother region is the center region.

According to some embodiments, the display panel may further include a second display region. According to some embodiments, the initialization voltage may further include a second region initialization voltage. According to some embodiments, the second region initialization voltage applied to the second display region may be inconsistent with the first region initialization voltage and the reference region initialization voltage.

According to some embodiments, the first region initialization voltage may be higher than the reference region initialization voltage.

According to some embodiments, the display device may further include an emission driver configured to output an emission signal to the pixel. According to some embodiments, at least one pixel of the pixels may include a first transistor including a control electrode connected to a first node, a first electrode connected to a second node and a second electrode connected to a third node, a second transistor configured to apply the data voltage to the second node in response to a write gate signal, a third transistor configured to connect the first node and the third node in response to a compensation gate signal, a fourth transistor configured to apply a data initialization voltage to the first node in response to an initialization gate signal, a fifth transistor configured to apply a high power voltage to the second node in response to the emission signal, a sixth transistor configured to connect the third node and a fourth node in response to the emission signal and a seventh transistor configured to apply the initialization voltage to the fourth node in response to the write gate signal. According to some embodiments, the first transistor may be the driving transistor, and the seventh transistor may be the initialization transistor. According to some embodiments, the first electrode of the light emitting element may be connected to the fourth node.

According to some embodiments, a display device may include a display panel including a plurality of pixels, a data driver configured to apply a data voltage to the display panel, a gate driver configured to output a gate signal to the pixels and a voltage generator configured to apply a low power voltage and an initialization voltage to the display panel. According to some embodiments, the display panel may include a first pixel column and a second pixel column. According to some embodiments, at least one pixel of the pixels may include a driving transistor configured to generate a driving current based on the data voltage, a light emitting element including a first electrode receiving the driving current and a second electrode receiving the low power voltage and an initialization transistor configured to apply the initialization voltage to the first electrode of the light emitting element. According to some embodiments, the initialization voltage may include a first column initialization voltage and a second column initialization voltage. According to some embodiments, the first column initialization voltage applied to the first pixel column may be inconsistent with the second column initialization voltage applied to the second pixel column.

According to some embodiments, the first column initialization voltage may be generated based on a reference initialization voltage and an initialization offset voltage. According to some embodiments, the initialization offset voltage may be calculated based on a difference of a luminance uniformity between at least one pixel included in the first pixel column and at least one pixel included in the second pixel column.

According to some embodiments, the difference of the luminance uniformity may be determined by changing the first column initialization voltage. According to some embodiments, the initialization offset voltage may be calculated based on a changed first column initialization voltage in a minimum luminance uniformity in which the difference of the luminance uniformity is minimum.

According to some embodiments, the luminance uniformity may be a ratio between a luminance when a reference data voltage is applied to the at least one pixel included in the second pixel column and a luminance when the reference data voltage is applied to the at least one pixel included in the first pixel column.

According to some embodiments, the display panel may be generated based on a mother panel. According to some embodiments, the reference initialization voltage may be generated based on a location data of the display panel in the mother panel.

According to some embodiments, the mother panel may include a first mother region and a second mother region. According to some embodiments, a reference initialization voltage of a display panel generated from the first mother region may be higher than a reference initialization voltage of a display panel generated from the second mother region.

According to some embodiments, the first column initialization voltage may be higher than the second column initialization voltage.

According to some embodiments, an electronic device may include a display panel including a plurality of pixels, a display panel driver configured to drive the display panel based on input image data and an input control signal, a processor configured to output the input image data and the input control signal and a power manager configured to output a driving voltage to the display panel. According to some embodiments, the driving voltage may include an initialization voltage and a low power voltage. According to some embodiments, the display panel may include a first display region and a reference display region. According to some embodiments, at least one pixel of the pixels may include a driving transistor configured to generate a driving current based on a data voltage, a light emitting element including a first electrode receiving the driving current and a second electrode receiving the low power voltage and an initialization transistor configured to apply the initialization voltage to the first electrode of the light emitting element. According to some embodiments, the initialization voltage may include a first region initialization voltage and a reference region initialization voltage. According to some embodiments, the first region initialization voltage applied to the first display region may be inconsistent with the reference region initialization voltage applied to the reference display region.

According to some embodiments, the first region initialization voltage may be generated based on a reference initialization voltage and an initialization offset voltage. According to some embodiments, the initialization offset voltage may be calculated based on a difference of a luminance uniformity between the reference display region and the first display region.

As described above, the initialization voltage may be stored in the display device based on the location data of the mother panel. Accordingly, the mother luminance uniformity according to the location of the mother panel may be compensated. The mother luminance uniformity according to the location of the mother panel may be compensated, so that a luminance reliability of the display device may be relatively improved. Additionally, a visibility of a stain of the display device may be relatively reduced.

According to some embodiments, different initialization voltages may be applied to each of the first to Nth display regions. The first to Nth area initialization voltages may be voltages in which the luminance characteristic is considered. Accordingly, a black characteristic of the display panel may be relatively improved.

Additionally, according to some embodiments, the target region initialization voltage may be a sum of the reference initialization voltage and the initialization offset voltage. Accordingly, the first electrode (e.g., anode) of the light emitting element may be initialized as a voltage higher than the reference initialization voltage. The first electrode (e.g., anode) of the light emitting element may be initialized as a voltage higher than the reference initialization voltage, so that the first electrode (e.g., anode) of the light emitting element may be initialized quickly. The first electrode (e.g., anode) of the light emitting element EE be initialized quickly, so that the stain visibility of the display panel may be relatively reduced. Accordingly, a black characteristic of the display panel may be relatively improved. Additionally, a display quality of the display panel may be relatively improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present disclosure.

FIG. 2 is a circuit diagram illustrating an example of pixel included in a display device of FIG. 1.

FIG. 3 is plan-view illustrating an example of a mother panel including a display panel of a display device of FIG. 1.

FIG. 4 is a diagram illustrating an example of a display panel included in a display device of FIG. 1.

FIG. 5 is a diagram illustrating pixel columns included in an N-the display region of a display panel of FIG. 4.

FIG. 6 is a diagram illustrating an example of a display panel included in a display device of FIG. 1.

FIG. 7 is a diagram illustrating an example of initialization voltages applied to a display panel.

FIG. 8 is a table illustrating an initialization offset voltage for generating initialization voltages of FIG. 7.

FIG. 9 is a flowchart illustrating a setting method of initialization voltage to a display device of FIG. 1.

FIG. 10 is a circuit diagram illustrating an example of a pixel included in a display device of FIG. 1.

FIG. 11 is a block diagram illustrating an electronic apparatus according to some embodiments of the present disclosure.

FIG. 12 is a diagram illustrating an example in which the electronic apparatus of FIG. 11 is implemented as a smart phone.

### DETAILED DESCRIPTION

Hereinafter, the present disclosure will be explained in detail with reference to the accompanying drawings.

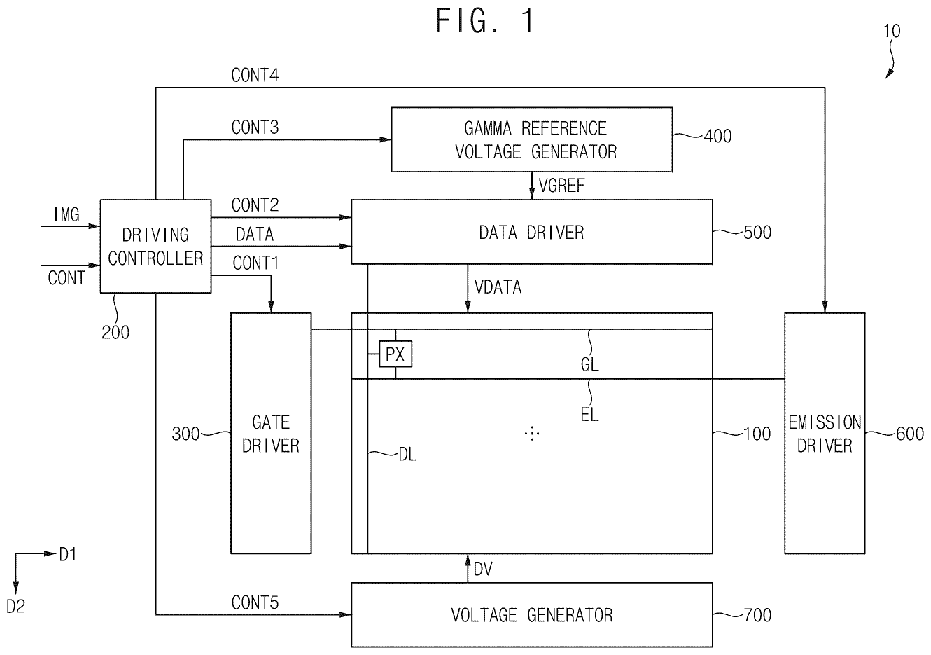

FIG. 1 is a block diagram illustrating a display device 10 according to embodiments of the present disclosure.

Referring to FIG. 1, the display device 10 may include a display panel 100 and a display panel driver. The display panel driver may include a driving controller 200, a gate driver 300, a gamma reference voltage generator 400, a data driver 500, an emission driver 600 and a voltage generator 700.

The display panel 100 may have a display region on which an image is displayed and a peripheral region adjacent to the display region.

The display panel 100 may include a plurality of gate lines GL, plurality of emission lines EL, a plurality of data lines DL and a plurality of pixels PX electrically connected to the gate lines GL, the emission lines EL and the data lines DL. The gate lines GL may extend in a first direction D1 and the data lines DL may extend in a second direction D2 crossing the first direction D1. The emission lines EL may extend in the first direction D1.

Although FIG. 1 illustrates a single pixel PX, a single gate line GL, a single emission line EL, and a single data line DL, as a person having ordinary skill in the art would appreciate, the display panel 100 may include any suitable number of pixels, gate lines, emission lines, and data lines according to the design and size of the display panel 100.

The driving controller 200 may receive input image data IMG and an input control signal CONT from an external apparatus. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate emission driver 300 based on the input control signal CONT, and output the first control signal CONT1 to the gate emission driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The driving controller 200 may generate the fifth control signal CONT5 for controlling an operation of the voltage generator 700 based on the input control signal CONT, and output the fifth control signal CONT5 to the voltage generator 700.

The gate driver 300 may generate gate signals driving the gate lines GL in response to the first control signal CONT1 received from the driving controller 200. The gate driver 300 may output the gate signals to the gate lines GL.

According to some embodiments, the gate driver 300 may be located in the peripheral region. According to some embodiments, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

According to some embodiments, the gamma reference voltage generator 400 may be located in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL.

According to some embodiments, the data driver 500 may be located in the peripheral region. According to some embodiments, the data driver 500 may be integrated in the peripheral region.

The emission driver 600 may generate emission signal in response to the fourth control signal CONT4 received from the driving controller 200. The emission driver 600 may output the emission signal to the display panel 100.

According to some embodiments, the emission driver 600 may be located in the peripheral region. According to some embodiments, the emission driver 600 may be integrated in the peripheral region.

Although the gate driver 300 is located on a first side of the display panel 100, and the emission driver 600 is located on a second side of the display panel 100 in FIG. 1 for convenience of explanation, the present disclosure is not limited thereto. The gate driver 300 and the emission driver 600 may be located on the first side of the display panel 100. For example, the gate driver 300 and the emission driver 600 may be located on the peripheral region of the display panel 100 on the same side of the display region of the display panel 100. For example, the gate driver 300 and the emission driver 600 may be formed integrally with each other.

The voltage generator 700 may generate a driving voltage DV in response to the fifth control signal CONT5 in response to the driving controller 200. The voltage generator 700 may output the driving voltage DV to the display panel 100. According to some embodiments, the driving voltage DV may include a high power voltage ELVDD, a low power voltage ELVSS, an initialization voltage VAINT. However, the present disclosure is not limited to a type of a voltage included in the driving voltage DV. For example, the driving voltage DV may further include gate voltages for generating the gate signals. For example, the driving voltage DV may further include gamma reference voltage for generating the gamma reference voltage VGREF.

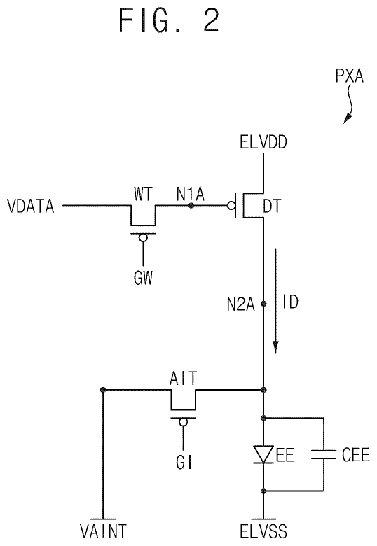

FIG. 2 is a circuit diagram illustrating an example of pixel PX included in a display device 1 of FIG. 1. Although FIG. 2 illustrates various components in a pixel PX according to some embodiments, embodiments according to the present disclosure are not limited thereto, and according to some embodiments, the pixel PX may include additional components or fewer components without departing from the spirit and scope of embodiments according to the present disclosure.

Referring to FIG. 1 and FIG. 2, a pixel PXA may include a driving transistor DT, a write transistor WT, an initialization transistor AIT, a light emitting element EE and a light emitting element capacitor CEE.

The driving transistor DT may include a control electrode connected to a first node N1A, a first electrode receiving the high power voltage ELVDD and a second electrode connected to a second node N2A. The driving transistor DT may generate a driving current ID based on a voltage of the first node N1A. The driving transistor DT may output the driving current ID to the second node N2A.

The write transistor WT may include a control electrode receiving the write gate signal GW, a first electrode receiving the data voltage VDATA and a second electrode connected to the first node N1A. The write gate signal WT may apply the data voltage VDATA to the first node N1A in response to the write gate signal GW.

The initialization transistor AIT may include a control electrode receiving the initialization gate signal GI, a first electrode receiving the initialization voltage VAINT and a second electrode connected to the second node N2A. The initialization transistor AIT may apply the initialization voltage VAINT to the second node N2A in response to the initialization gate signal GI. According to some embodiments, the initialization voltage VAINT may be lower than the low power voltage ELVSS. The initialization transistor AIT may be called as a light emitting element initialization transistor.

The light emitting element EE may include a first electrode connected to the second node N2A and a second electrode receiving the low power voltage ELVSS. The light emitting element EE may emit light based on the driving current ID. According to some embodiments, the light emitting element EE may be, but is not limited to, an organic light emitting diode OLED. In other embodiments, the light emitting element EE may be a nano light emitting diode (NED), a quantum dot (QD) light emitting diode, a micro light emitting diode, an inorganic light emitting diode, or any other suitable light emitting element.

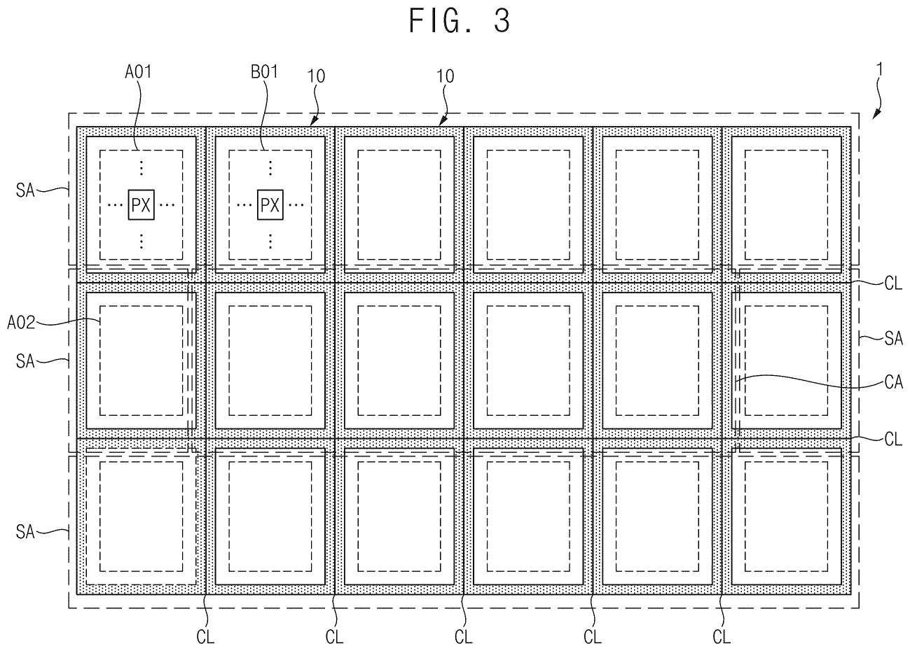

FIG. 3 is plan-view illustrating an example of a mother panel 1 including a display panel 100 of a display device 1 of FIG. 1.

Referring to FIG. 1 to FIG. 3, the display device 10 may be formed in multiple devices in the mother panel 1. The display device 10 may be generated based on the mother panel 1. The display device 10 may be generated based on the mother panel 1. The display device 10 may be generated by cutting a cutting line CL on the mother panel 1. For example, the mother panel 1 may be cut by using a laser cutter and/or blade, and etc.

The mother panel may include an edge region SA and a center region CA. For example, the edge region SC may be called as a first mother region. For example, the center region CA may be called as a second mother region.

A luminance of the display device 10 may be different based on a location of the mother panel 1. A setting luminance of the display device 10 generated based on a first mother panel region A01 may be inconsistent with a setting luminance of the display device 10 generated based on a second mother panel region B01. A setting luminance of the display device 10 generated based on the second mother panel region B01 may be inconsistent with a setting luminance of the display device 10 generated based on a third mother panel region A02. A setting luminance of the display device 10 generated based on the edge region SA may be inconsistent with a setting luminance of the display device 10 generated based on the center region CA. The setting luminance may be a luminance at which each of the display panels 100 of the display devices 10 emits light when a target voltage is applied to the mother panel 1 in order for the mother panel 1 to emit light at a specific luminance. The mother luminance uniformity of the mother panel 1 may be determined by applying the target voltage to the mother panel 1. For example, a luminance of the mother panel 1 may be measured using an external device (e.g., a sensor, a camera, etc.). The mother luminance uniformity may be determined based on the measured luminance.

According to some embodiments, the initialization voltage VAINT may be stored in the display device 10 based on location data of the mother panel 1. According to some embodiments, the initialization voltage VAINT corresponding to the mother luminance uniformity which corresponds to the location data of the mother panel 1 may be determined. For example, the initialization voltage VAINT stored in the display device 10 based on the location of the mother panel 1 may be called as a reference initialization voltage.

Different reference initialization voltages may be stored in the display device 10 based on the location of the mother panel 1. The reference initialization voltage of the display device 10 generated based on the edge region SA and the reference initialization voltage of the display device 10 generated based on the center region CA may be different. For example, the reference initialization voltage of the display device 10 generated based on the edge region SA may be different from the reference initialization voltage of the display device 10 generated based on the center region CA. For example, the reference initialization voltage of the display device 10 generated based on the edge region SA may be higher than the reference initialization voltage of the display device 10 generated based on the center region CA.

Generally, the setting luminance of the edge region of the mother panel may be different from the setting luminance of a center region. For example, the setting luminance of the edge region of the mother panel may be different from the setting luminance of the center region. When an initialization voltage that does not take into account the location data of the mother panel is stored, a luminance reliability of the display device may be deteriorated.

The initialization voltage VAINT may be stored in the display device 10 based on the location data of the mother panel 1, the mother luminance uniformity according to the location of the mother panel 1 may be compensated. For example, the reference initialization voltage of the display device 10 generated based on the edge region SA and the reference initialization voltage of the display device 10 generated based on the center region CA may be stored differently. Accordingly, the mother luminance uniformity according to the location of the mother panel 1 may be compensated. The mother luminance uniformity according to the location of the mother panel 1 may be compensated, so that a luminance reliability of the display device 10 may be relatively improved. Additionally, a visibility of a stain of the display device 10 may be relatively reduced.

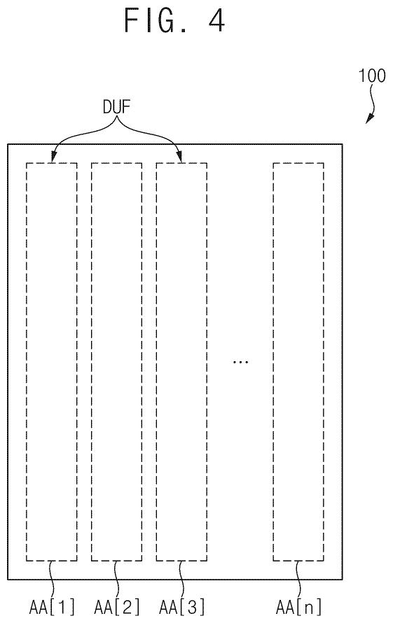

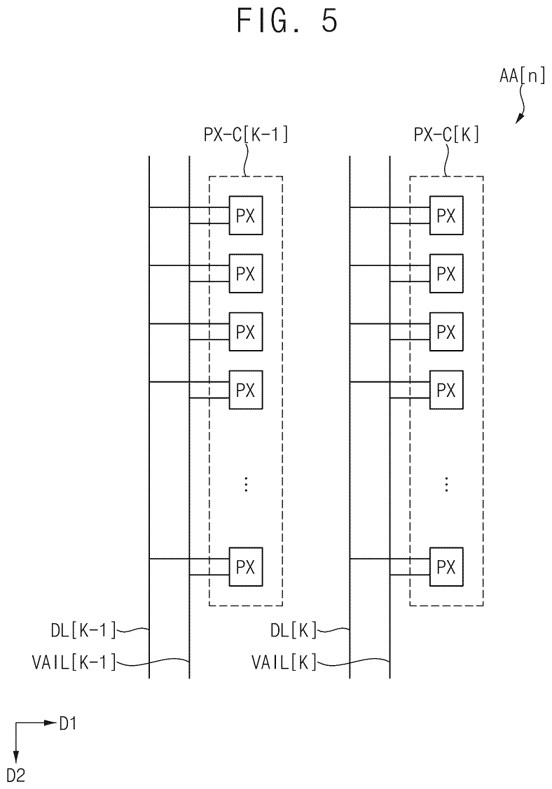

FIG. 4 is a diagram illustrating an example of a display panel 100 included in a display device 10 of FIG. 1. FIG. 5 is a diagram illustrating pixel columns PX-C[K−1] and PX-C[K] included in an N-the display region AA[n] of a display panel 100 of FIG. 4.

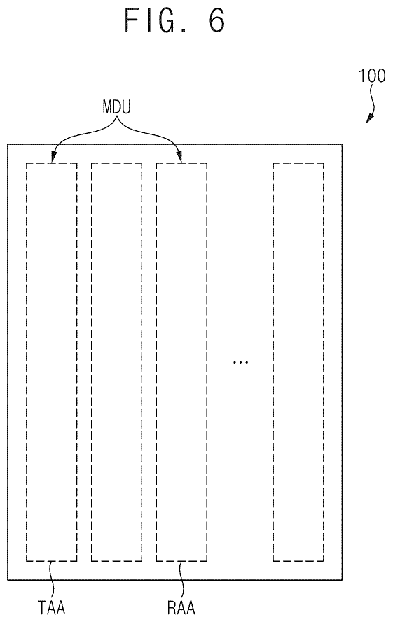

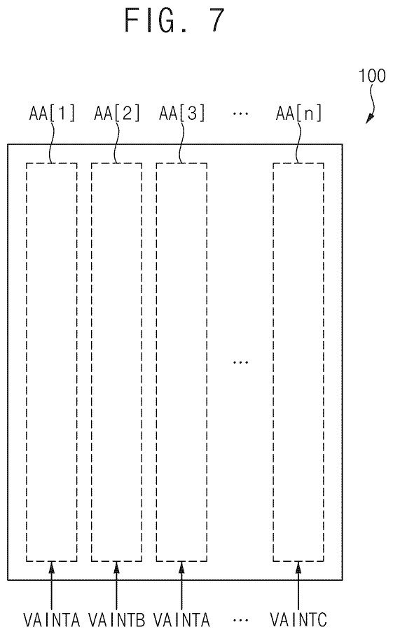

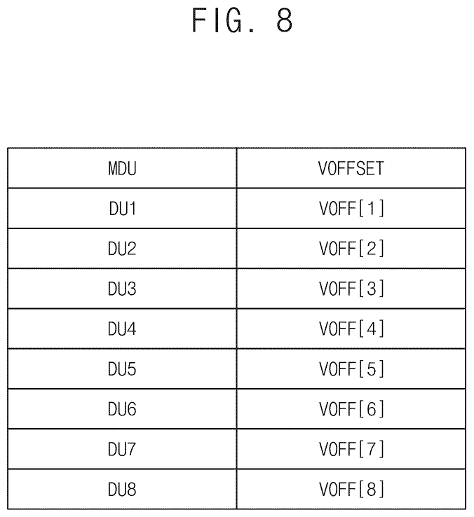

FIG. 6 is a diagram illustrating an example of a display panel 100 included in a display device 10 of FIG. 1. FIG. 7 is a diagram illustrating an example of initialization voltages VAINTA, VAINTB and VAINTC applied to a display panel 100. FIG. 8 is a table illustrating an initialization offset voltage VOFFSET for generating initialization voltages VAINTA, VAINTB and VAINTC of FIG. 7.

Referring to FIG. 1 to FIG. 8, the display panel 100 may include first to N-th display regions AA[1], AA[2], AA[3] to AA[n]. The display panel 100 may include first to K-th pixel columns. The N-th display region AA[n] may include a plurality of pixel columns. For example, the N-th display region AA[n] may include a K−1-th pixel column PX-C[K−1] and a K-th pixel column PX-C[K]. However, the present disclosure is not limited to the number of pixel-columns included in a display region of the display panel 100.

The K−1-th pixel column PX-C[K−1] may include a plurality of the pixels PX. The K−1-th pixel column PX-C[K−1] may be connected to a K−1-th data line DL[K−1]. The K−1-th pixel column PX-C[K−1] may be connected to a K−1-th initialization voltage line VAIL[K−1]. The initialization voltage VAINT may be applied to the K−1-th initialization voltage line VAIL[K−1]. The K-th pixel column PX-C[K] may include a plurality of the pixels PX. The K-th pixel column PX-C[K] may be connected to a K-th data line DL[K]. The K-th pixel column PX-C[K] may be connected to a K-th initialization voltage line VAIL[K]. The initialization voltage VAINT may be applied to the K-th initialization voltage line VAIL[K]. The K−1-th initialization voltage line VAIL[K−1] and the K-th initialization voltage line VAIL[1] may extend to the second direction D2.

Based on process characteristics, luminance characteristics of each of the first to Nth display regions AA[1], AA[2], AA[3], . . . , AA[n] may be different. For example, when the reference data voltage is applied to the first to Nth display regions AA[1], AA[2], AA[3], . . . , AA[n], each of the first to Nth display regions AA[1], AA[2], AA[3], . . . , AA[n] may emit light with different luminance depending on the process characteristics. The luminance characteristics may be different, so that a black characteristic of the display panel 100 may be deteriorated.

For example, the luminance of the display panel 100 may be determined by using the external device (e.g., sensor, camera, and etc.). The luminance characteristic may be determined based on the measured luminance. For example, a region in which the luminance characteristic is maximum may be a reference display region RAA. For example, a region with a maximum luminance characteristic may be a region that emits light with a target luminance when the reference data voltage is applied. According to some embodiments, for example, the region with the maximum luminance characteristic may be a region that emits light with a luminance that is substantially same as the target luminance when the reference data voltage is applied. The initialization voltage VAINT applied to the reference display region RAA may be called as a reference region initialization voltage.

A luminance uniformity DUF may be determined based on the initialization voltage VAINT and the reference data voltage. The luminance uniformity DUF may be a ratio between a luminance when the reference data voltage is applied to the reference display region RAA and a luminance when the reference data voltage is applied to target display region TAA. The target display region TAA may be any one of the display regions among the first to Nth display regions AA[1], AA[2], AA[3], . . . , AA[n] excluding the reference display region RAA.

The initialization voltages VAINT applied to first to Nth display regions AA[1], AA[2], AA[3], . . . , AA[n] may be changed. For example, the initialization voltage VAINT may be changed in a manufacturing process of the display device 10. The first to Nth 1 display regions AA[1], AA[2], AA[3], . . . , AA[n] may be changed, so that the luminance uniformity DUF of the target display region TAA may be changed.

The initialization voltage VAINT applied to the first display region AA[1] may be changed. The initialization voltage VAINT applied to the first display region AA[1] may be called as a first region initialization voltage. The first region initialization voltage corresponding to a minimum luminance uniformity MDU may be determined. The minimum luminance uniformity MDU may be the luminance uniformity DUF at which a difference between the luminance uniformity DUF of the first display region AA[1] corresponding to the changed first region initialization voltage and the luminance uniformity DUF of the reference display region RAA are the minimum. The first region initialization voltage corresponding to the minimum luminance uniformity MDU may be a first initialization voltage VAINTA. When the display panel 100 is driven, the first initialization voltage VAINTA may be applied to the first display region AA[1].

The initialization voltage VAINT applied to the second display region AA[2] may be changed. The initialization voltage VAINT applied to the second display region AA[2] may be called as a second region initialization voltage. The second region initialization voltage corresponding to a minimum luminance uniformity MDU may be determined. The minimum luminance uniformity MDU may be the luminance uniformity DUF at which a difference between the luminance uniformity DUF of the second display region AA[2] corresponding to the changed second region initialization voltage and the luminance uniformity DUF of the reference display region RAA are the minimum. The second region initialization voltage corresponding to the minimum luminance uniformity MDU may be a second initialization voltage VAINTB. The first initialization voltage VAINTA may be inconsistent with the second initialization voltage VAINTB. When the display panel 100 is driven, the second initialization voltage VAINTB may be applied to the second display region AA[2].

The initialization voltage VAINT applied to the third display region AA[3] may be changed. The initialization voltage VAINT applied to the third display region AA[3] may be called as a third region initialization voltage. The third region initialization voltage corresponding to a minimum luminance uniformity MDU may be determined. The minimum luminance uniformity MDU may be the luminance uniformity DUF at which a difference between the luminance uniformity DUF of the third display region AA[3] corresponding to the changed third region initialization voltage and the luminance uniformity DUF of the reference display region RAA are the minimum. The third region initialization voltage corresponding to the minimum luminance uniformity MDU may be the first initialization voltage VAINTA. When the display panel 100 is driven, the first initialization voltage VAINTA may be applied to the third display region AA[3].

The initialization voltage VAINT applied to the N-th display region AA[n] may be changed. The initialization voltage VAINT applied to the N-th display region AA[n] may be called as an N-th region initialization voltage. The N-th region initialization voltage corresponding to a minimum luminance uniformity MDU may be determined. The minimum luminance uniformity MDU may be the luminance uniformity DUF at which a difference between the luminance uniformity DUF of the N-th display region AA[n] corresponding to the changed third region initialization voltage and the luminance uniformity DUF of the reference display region RAA are the minimum. The N-th region initialization voltage corresponding to the minimum luminance uniformity MDU may be a third initialization voltage VAINTC. The first third initialization voltage VAINTC may be inconsistent with the first initialization voltage VAINTA and the second initialization voltage VAINTB. When the display panel 100 is driven, the third initialization voltage VAINTC may be applied to the N-th display region AA[n].

According to some embodiments, the first region initialization voltage may be higher than the reference region initialization voltage. For example, the initialization voltage VAINT applied to a display region of edge of the display panel 100 may be higher than the reference region initialization voltage.

According to some embodiments, first to N-th region initialization voltages corresponding to the first to N-th display regions AA[1], AA[2], AA[3], to AA[n] may be generated based on the reference initialization voltage and an initialization offset voltage VOFFSET.

The initialization offset voltage VOFFSET may be calculated based on a difference of the luminance uniformity DUF between the reference display region RAA and the target display region TAA. For example, initialization offset voltage VOFFSET may be determined based on a difference of the minimum luminance uniformity MDU between the reference display region RAA and the target display region TAA. The initialization offset voltage VOFFSET may be calculated based on a difference of the luminance uniformity DUF between the reference display region RAA and the target display region TAA.

When a minimum luminance uniformity MDU between the reference display region RAA and the target display region TAA has a first luminance uniformity DU1, a first initialization offset voltage VOFFSET[1] and the reference initialization voltage may be considered to a target region initialization voltage. For example, when the minimum luminance uniformity MDU between the reference display region RAA and the target display region TAA has the first luminance uniformity DU1, the target region initialization voltage may be a sum of the first initialization offset voltage VOFFSET[1] and the reference initialization voltage. For example, the first initialization offset voltage VOFFSET[1] may be about 0.025V.

When a minimum luminance uniformity MDU between the reference display region RAA and the target display region TAA has a second luminance uniformity DU2, a second initialization offset voltage VOFFSET[2] and the reference initialization voltage may be considered to a target region initialization voltage. For example, when the minimum luminance uniformity MDU between the reference display region RAA and the target display region TAA has the second luminance uniformity DU2, the target region initialization voltage may be a sum of the second initialization offset voltage VOFFSET[2] and the reference initialization voltage. For example, the second initialization offset voltage VOFFSET[2] may be about 0.05V.

When a minimum luminance uniformity MDU between the reference display region RAA and the target display region TAA has a third luminance uniformity DU3, a third initialization offset voltage VOFFSET[3] and the reference initialization voltage may be considered to a target region initialization voltage. For example, when the minimum luminance uniformity MDU between the reference display region RAA and the target display region TAA has the third luminance uniformity DU3, the target region initialization voltage may be a sum of the third initialization offset voltage VOFFSET[3] and the reference initialization voltage. For example, the third initialization offset voltage VOFFSET[3] may be about 0.075V.

When a minimum luminance uniformity MDU between the reference display region RAA and the target display region TAA has a fourth luminance uniformity DU4, a fourth initialization offset voltage VOFFSET[4] and the reference initialization voltage may be considered to a target region initialization voltage. For example, when the minimum luminance uniformity MDU between the reference display region RAA and the target display region TAA has the fourth luminance uniformity DU4, the target region initialization voltage may be a sum of the fourth initialization offset voltage VOFFSET[4] and the reference initialization voltage. For example, the fourth initialization offset voltage VOFFSET[4] may be about 0.1V.

When a minimum luminance uniformity MDU between the reference display region RAA and the target display region TAA has a fifth luminance uniformity DU5, a fifth initialization offset voltage VOFFSET[5] and the reference initialization voltage may be considered to a target region initialization voltage. For example, when the minimum luminance uniformity MDU between the reference display region RAA and the target display region TAA has the fifth luminance uniformity DU5, the target region initialization voltage may be a sum of the fifth initialization offset voltage VOFFSET[5] and the reference initialization voltage. For example, the fifth initialization offset voltage VOFFSET[5] may be about 0.125V.

When a minimum luminance uniformity MDU between the reference display region RAA and the target display region TAA has a sixth luminance uniformity DU6, a sixth initialization offset voltage VOFFSET[6] and the reference initialization voltage may be considered to a target region initialization voltage. For example, when the minimum luminance uniformity MDU between the reference display region RAA and the target display region TAA has the sixth luminance uniformity DU6, the target region initialization voltage may be a sum of the sixth initialization offset voltage VOFFSET[6] and the reference initialization voltage. For example, the sixth initialization offset voltage VOFFSET[6] may be about 0.15V.

When a minimum luminance uniformity MDU between the reference display region RAA and the target display region TAA has a seventh luminance uniformity DU7, a seventh initialization offset voltage VOFFSET[7] and the reference initialization voltage may be considered to a target region initialization voltage. For example, when the minimum luminance uniformity MDU between the reference display region RAA and the target display region TAA has the seventh luminance uniformity DU7, the target region initialization voltage may be a sum of the seventh initialization offset voltage VOFFSET[7] and the reference initialization voltage. For example, the seventh initialization offset voltage VOFFSET[7] may be about 0.175V.

When a minimum luminance uniformity MDU between the reference display region RAA and the target display region TAA has an eighth luminance uniformity DU8, an eighth initialization offset voltage VOFFSET[8] and the reference initialization voltage may be considered to a target region initialization voltage. For example, when the minimum luminance uniformity MDU between the reference display region RAA and the target display region TAA has the eighth luminance uniformity DU8, the target region initialization voltage may be a sum of the eighth initialization offset voltage VOFFSET[8] and the reference initialization voltage. For example, the eighth initialization offset voltage VOFFSET[8] may be about 0.2V. However, the present disclosure is not limited to values of the first to eighth initialization offset voltages VOFFSET[1], VOFFSET[2], VOFFSET[3], VOFFSET[4], VOFFSET[5], VOFFSET[6], VOFFSET[7] and VOFFSET[8]. Additionally, the present disclosure is not limited to the number of the initialization offset voltages VOFFSET.

According to some embodiments, a maximum initialization offset voltage of the initialization offset voltage VOFFSET may be set. The maximum initialization offset voltage may be set considering a black data voltage. The black data voltage may be the data voltage such that the display panel 100 may display black. The maximum offset voltage may be set, so that the display panel 100 may display black stably based on the black data voltage.

According to some embodiments, the initialization voltage VAINT may include a first column initialization voltage and a second column initialization voltage. The first column initialization voltage may be applied to a first pixel column. The second column initialization voltage may be applied to a second pixel column. The first column initialization voltage may be inconsistent with the second column initialization voltage. According to some embodiments, the first column initialization voltage may be higher than the second column initialization voltage.

According to some embodiments, the first column initialization voltage may be generated based on the reference initialization voltage and the initialization offset voltage VOFFSET. The initialization offset voltage VOFFSET may be calculated based on a difference of the luminance uniformity DUF between at least one pixel PX included in the first pixel column and at least one pixel PX included in the second pixel column. The difference of the luminance uniformity DUF may be determined by changing the first column initialization voltage. The initialization offset voltage VOFFSET may be calculated based on the changed first column initialization voltage in the minimum luminance uniformity MDU in which the difference of the luminance uniformity DUF is minimum. The luminance uniformity may be a ratio between a luminance when a reference data voltage is applied to the at least one pixel included in the second pixel column and a luminance when the reference data voltage is applied to the at least one pixel included in the first pixel column.

According to some embodiments, different initialization voltages VAINT may be applied to each of the first to Nth display regions AA[1], AA[2], AA[3] to AA[n]. The first to Nth area initialization voltages may be voltages in which the luminance characteristic is considered. Accordingly, a black characteristic of the display panel 100 may be relatively improved.

Additionally, according to some embodiments, the target region initialization voltage may be a sum of the reference initialization voltage and the initialization offset voltage VOFFSET. Accordingly, the first electrode (e.g., anode) of the light emitting element EE may be initialized as a voltage higher than the reference initialization voltage. The first electrode (e.g., anode) of the light emitting element EE may be initialized as a voltage higher than the reference initialization voltage, so that the first electrode (e.g., anode) of the light emitting element EE may be initialized relatively quickly. The first electrode (e.g., anode) of the light emitting element EE may be initialized relatively quickly, so that the stain visibility of the display panel 100 may be relatively reduced. Accordingly, a black characteristic of the display panel 100 may be relatively improved. Additionally, a display quality of the display panel 100 may be relatively improved.

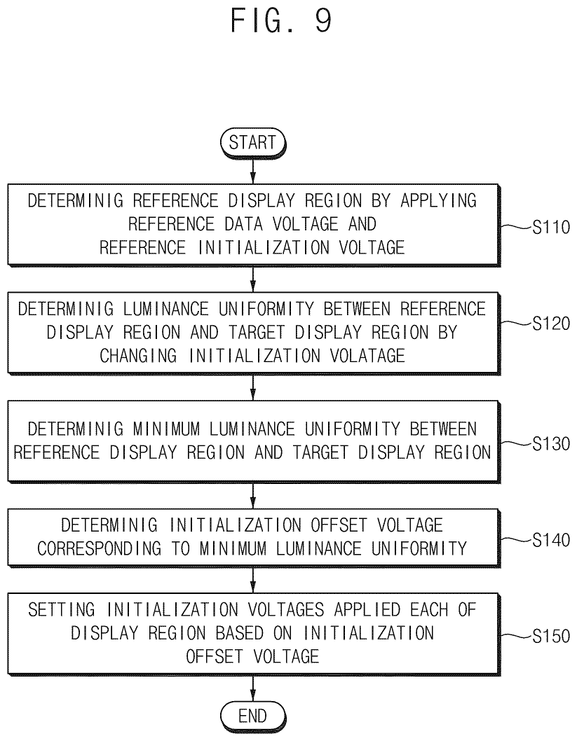

FIG. 9 is a flowchart illustrating aspects of a setting method of initialization voltage VAINT to a display device 10 of FIG. 1. Although FIG. 9 illustrates various operations in a setting method, embodiments according to the present disclosure are not limited thereto, and according to some embodiments, the setting method may include additional operations, or fewer operations, or the order of operations may vary, unless otherwise stated or implied, without departing from the spirit and scope of embodiments according to the present disclosure.

Referring to FIG. 1 to FIG. 9, a setting method of initialization voltage VAINT to the display device 10 may include determining reference display region RAA by applying the reference data voltage and the reference initialization voltage (S110), determining the luminance uniformity between the reference display region RAA and the target display region TAA by changing the initialization voltage VAINT (S120), determining the minimum luminance uniformity MDU between the reference display region RAA and the target display region TAA (S130), determining the initialization offset voltage VOFFSET corresponding to the minimum luminance uniformity MDU (S140), and setting initialization voltage VAINT applied to each of display region based on the initialization offset voltage VOFFSET (S150). The setting method of the initialization voltage VAINT to the display device 10 may be performed in a manufacturing process. For example, a first device (e.g., camera, sensor, and etc.) may perform the method of the determining reference display region RAA by applying the reference data voltage and the reference initialization voltage (S110), determining the luminance uniformity between the reference display region RAA and the target display region TAA by changing the initialization voltage VAINT (S120), and determining the minimum luminance uniformity MDU between the reference display region RAA and the target display region TAA (S130) in the manufacturing process of the display device 10. A second device (e.g., sensor, camera, and etc.) may perform the method of determining the initialization offset voltage VOFFSET corresponding to the minimum luminance uniformity MDU (S140), and setting initialization voltage VAINT applied to each of display region based on the initialization offset voltage VOFFSET (S150). For example, the second device may be Multi-time programming performing device. According to some embodiments, the first device and the second device may be an integration device.

According to some embodiments, different initialization voltages VAINT may be applied to each of the first to Nth display regions AA[1], AA[2], AA[3] to AA[n]. The first to Nth area initialization voltages may be voltages in which the luminance characteristic is considered. Accordingly, a black characteristic of the display panel 100 may be relatively improved.

Additionally, according to some embodiments, the target region initialization voltage may be a sum of the reference initialization voltage and the initialization offset voltage VOFFSET. Accordingly, the first electrode (e.g., anode) of the light emitting element EE may be initialized as a voltage higher than the reference initialization voltage. The first electrode (e.g., anode) of the light emitting element EE may be initialized as a voltage higher than the reference initialization voltage, so that the first electrode (e.g., anode) of the light emitting element EE may be initialized quickly. The first electrode (e.g., anode) of the light emitting element EE may be initialized quickly, so that the stain visibility of the display panel 100 may be relatively reduced. Accordingly, a black characteristic of the display panel 100 may be relatively improved. Additionally, a display quality of the display panel 100 may be relatively improved.

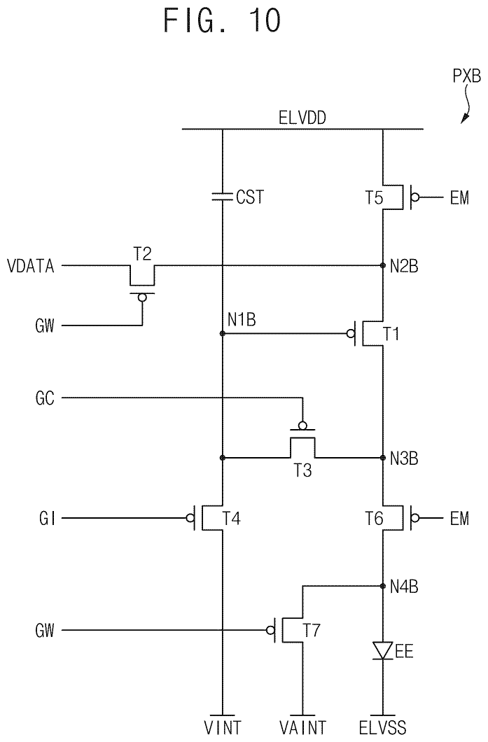

FIG. 10 is a circuit diagram illustrating an example of a pixel PX included in a display device 10 of FIG. 1. Although FIG. 10 illustrates various components in a pixel PX according to some embodiments, embodiments according to the present disclosure are not limited thereto, and according to various embodiments, the pixel may include additional components or fewer components without departing from the spirit and scope of embodiments according to the present disclosure.

Referring to FIG. 1 and FIG. 10, a pixel circuit PXB may include a first transistor T1, a second transistor T2, a third transistor T3, a fourth transistor T4, a fifth transistor T5, a sixth transistor T6, a seventh transistor T7 and a storage capacitor CST.

The first transistor T1B may include a control electrode connected to a first node N1B, a first electrode connected to a second node N2B and a second electrode connected to a third node N3B. The first transistor T1B may generate a driving current based on a voltage of the first node N1B. For example, the first transistor T1B may be called as a driving transistor.

The second transistor T2B may include a control electrode receiving a write gate signal GW, a first electrode receiving the data voltage VDATA and a second electrode connected to the second node N2B. The second transistor T2B may apply the data voltage VDATA to the second node N2B in response to the write gate signal GW. For example, the second transistor T2B may be called as a write transistor.

The third transistor T3B may include a control electrode receiving the compensation gate signal GC, a first electrode connected to the third node N3B and a second electrode connected to the first node N1B. The third transistor T3B may connect the first node N1B and the third node N3B in response to the compensation gate signal GC. For example, the third transistor T3B may diode-connect the first transistor T1B in response to the compensation gate signal GC. For example, the third transistor T3B may be called as the compensation transistor.

The fourth transistor T4B may include a control electrode receiving the initialization gate signal GI, a first electrode receiving a data initialization voltage VINT and a second electrode connected to the first node N1B. The fourth transistor T4B may apply the data initialization voltage VINT to the first node N1B in response to the initialization gate signal GI. For example, the fourth transistor T4B may be called as the initialization transistor.

The fifth transistor T5B may include a control electrode receiving the emission signal EM, a first electrode receiving the first power voltage ELVDD and a second electrode connected to the second node N2. The fifth transistor T5B may apply the first power voltage ELVDD to the second node N2B in response to the emission signal EM. For example, the fifth transistor T5B may be called as a first emission transistor.

The sixth transistor T6B may include a control electrode receiving the emission signal EM, a first electrode connected to the third node N3B and a second electrode connected to a fourth node N4B. The sixth transistor T6B may connect the third node N3B and the fourth node N4B in response to the emission signal EM. For example, the sixth transistor T6B may be called as a second emission transistor.

The seventh transistor T7B may include a control electrode receiving the write gate signal GW, a first electrode receiving the initialization voltage VAINT and a second electrode connected to the fourth node N4B. The seventh transistor T7B may apply the initialization voltage VAINT to the fourth node N4B in response to the write gate signal GW. For example, the seventh transistor T7 may be called as a light emitting element initialization transistor.

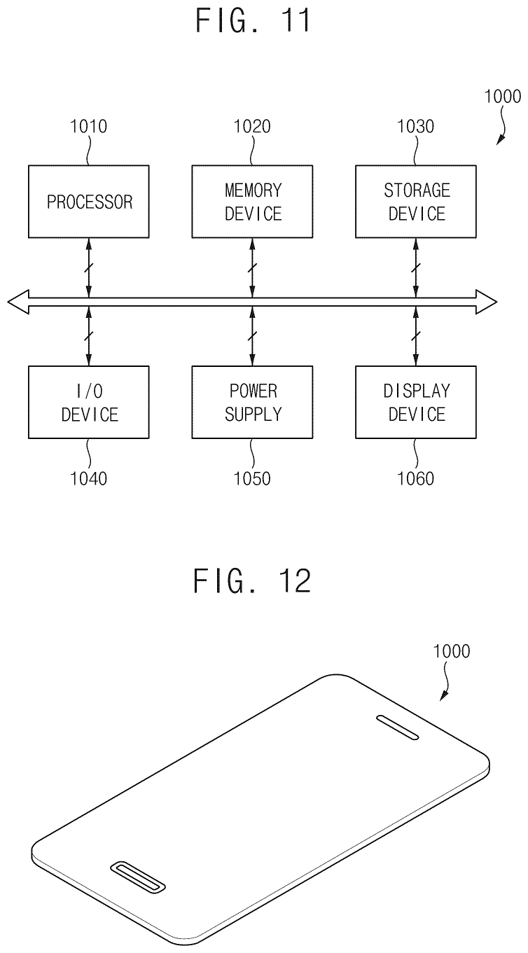

FIG. 11 is a block diagram illustrating an electronic apparatus 1000 according to some embodiments of the present disclosure. FIG. 12 is a diagram illustrating an example in which the electronic apparatus of FIG. 11 is implemented as a smart phone.

Referring to FIG. 1 and FIG. 11, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. Additionally, the electronic apparatus 1000 may further include a plurality of ports for communicating with a video card, a sound card, a memory card, a universal serial bus (USB) device, other electronic apparatus, etc.

According to some embodiments, as illustrated in FIG. 12, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

Referring to FIG. 12, the electronic apparatus of the present disclosure is shown implemented as a smartphone, but the present disclosure is not limited thereto. The electronic apparatus may be a television, a monitor, a laptop computer, or a tablet. Additionally, the electronic apparatus may be a car.

The display apparatus according to the embodiments may be applied to a display apparatus included in a computer, a notebook, a mobile phone, a smart phone, a smart pad, a PMP, a PDA, an MP3 player, or the like.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and characteristics of embodiments according to the present disclosure. Accordingly, all such modifications are intended to be included within the scope of the present disclosure as defined in the claims, and their equivalents. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims, and their equivalents. The present disclosure is defined by the following claims, with equivalents of the claims to be included therein.

What is claimed is:

1. A display device comprising:
a display panel including a plurality of pixels;
a data driver configured to apply a data voltage to the display panel;
a gate driver configured to output a gate signal to the pixels; and
a voltage generator configured to apply a low power voltage and an initialization voltage to the display panel,
wherein the display panel includes a first display region and a reference display region,
wherein at least one pixel of the pixels includes:
a driving transistor configured to generate a driving current based on the data voltage;
a light emitting element including a first electrode configured to receive the driving current and a second electrode configured to receive the low power voltage; and
an initialization transistor configured to apply the initialization voltage to the first electrode of the light emitting element,
wherein the initialization voltage includes a first region initialization voltage and a reference region initialization voltage, and
wherein the first region initialization voltage applied to the first display region is inconsistent with the reference region initialization voltage applied to the reference display region.

2. The display device of claim 1, wherein the first region initialization voltage is generated based on a reference initialization voltage and an initialization offset voltage, and
wherein the initialization offset voltage is calculated based on a difference of a luminance uniformity between the reference display region and the first display region.

3. The display device of claim 2, wherein the difference of the luminance uniformity is determined by changing the first region initialization voltage, and
wherein the initialization offset voltage is calculated based on a changed first region initialization voltage in a minimum luminance uniformity in which the difference of the luminance uniformity is minimum.

4. The display device of claim 2, wherein the luminance uniformity is a ratio between a luminance for which a reference data voltage is applied to the reference display region and a luminance for which the reference data voltage is applied to the first display region.

5. The display device of claim 4, wherein based on the reference datavoltage being applied to the reference display region, the reference display region is configured to emit as a target luminance.

6. The display device of claim 2, wherein the display panel is generated based on a mother panel, and
wherein the reference initialization voltage is generated based on a location data of the display panel in the mother panel.

7. The display device of claim 6, wherein the mother panel includes a first mother region and a second mother region, and
wherein a reference initialization voltage of a display panel generated from the first mother region is higher than a reference initialization voltage of a display panel generated from the second mother region.

8. The display device of claim 7, wherein the mother panel includes a center region and an edge region, and
wherein the first mother region is the edge region and a second mother region is the center region.

9. The display device of claim 1, wherein the display panel further includes a second display region,
wherein the initialization voltage further includes a second region initialization voltage, and
wherein the second region initialization voltage applied to the second display region is inconsistent with the first region initialization voltage and the reference region initialization voltage.

10. The display device of claim 1, wherein the first region initialization voltage is higher than the reference region initialization voltage.

11. The display device of claim 1, further comprising an emission driver configured to output an emission signal to the at least one pixel,
wherein the at least one pixel of the pixels includes:
a first transistor including a control electrode connected to a first node, a first electrode connected to a second node and a second electrode connected to a third node;
a second transistor configured to apply the data voltage to the second node in response to a write gate signal;
a third transistor configured to connect the first node and the third node in response to a compensation gate signal;
a fourth transistor configured to apply a data initialization voltage to the first node in response to an initialization gate signal;
a fifth transistor configured to apply a high power voltage to the second node in response to the emission signal;
a sixth transistor configured to connect the third node and a fourth node in response to the emission signal; and
a seventh transistor configured to apply the initialization voltage to the fourth node in response to the write gate signal,
wherein the first transistor is the driving transistor, and the seventh transistor is the initialization transistor, and
wherein the first electrode of the light emitting element is connected to the fourth node.

12. A display device comprising:
a display panel including a plurality of pixels;
a data driver configured to apply a data voltage to the display panel;
a gate driver configured to output a gate signal to the pixels; and
a voltage generator configured to apply a low power voltage and an initialization voltage to the display panel,
wherein the display panel includes a first pixel column and a second pixel column,
wherein at least one pixel of the pixels includes:
a driving transistor configured to generate a driving current based on the data voltage;
a light emitting element including a first electrode configured to receive the driving current and a second electrode configured to receive the low power voltage; and
an initialization transistor configured to apply the initialization voltage to the first electrode of the light emitting element,
wherein the initialization voltage includes a first column initialization voltage and a second column initialization voltage, and
wherein the first column initialization voltage applied to the first pixel column is inconsistent with the second column initialization voltage applied to the second pixel column.

13. The display device of claim 12, wherein the first column initialization voltage is generated based on a reference initialization voltage and an initialization offset voltage, and
wherein the initialization offset voltage is calculated based on a difference of a luminance uniformity between at least one pixel included in the first pixel column and at least one pixel included in the second pixel column.

14. The display device of claim 13, wherein the difference of the luminance uniformity is determined by changing the first column initialization voltage, and
wherein the initialization offset voltage is calculated based on a changed first column initialization voltage in a minimum luminance uniformity in which the difference of the luminance uniformity is minimum.

15. The display device of claim 13, wherein the luminance uniformity is a ratio between a luminance for which a reference data voltage is applied to the at least one pixel included in the second pixel column and a luminance for which the reference data voltage is applied to the at least one pixel included in the first pixel column.

16. The display device of claim 13, wherein the display panel is generated based on a mother panel, and
wherein the reference initialization voltage is generated based on a location data of the display panel in the mother panel.

17. The display device of claim 16, wherein the mother panel includes a first mother region and a second mother region, and
wherein a reference initialization voltage of a display panel generated from the first mother region is higher than a reference initialization voltage of a display panel generated from the second mother region.

18. The display device of claim 12, wherein the first column initialization voltage is higher than the second column initialization voltage.

19. An electronic device comprising:
a display panel including a plurality of pixels;
a display panel driver configured to drive the display panel based on input image data and an input control signal;
a processor configured to output the input image data and the input control signal; and
a power manager configured to output a driving voltage to the display panel,
wherein the driving voltage includes an initialization voltage and a low power voltage,
wherein the display panel includes a first display region and a reference display region,
wherein at least one pixel of the pixels includes:
a driving transistor configured to generate a driving current based on a data voltage;
a light emitting element including a first electrode configured to receive the driving current and a second electrode configured to receive the low power voltage; and
an initialization transistor configured to apply the initialization voltage to the first electrode of the light emitting element,
wherein the initialization voltage includes a first region initialization voltage and a reference region initialization voltage, and
wherein the first region initialization voltage applied to the first display region is inconsistent with the reference region initialization voltage applied to the reference display region.

20. The electronic device of claim 19, wherein the first region initialization voltage is generated based on a reference initialization voltage and an initialization offset voltage, and
wherein the initialization offset voltage is calculated based on a difference of a luminance uniformity between the reference display region and the first display region.
